(19) United States
(12) Patent Application Publication
(10) Pub. No.: US 2017/0193608 A1
(43) Pub. Date: Jul. 6, 2017

(54) SYSTEM AND METHOD FOR AUTOMATICALLY GENERATING REPORTING DATA BASED ON ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/415,286

(22) Filed: Jan. 25, 2017

Related U.S. Application Data
(63) Continuation-in-part of application No. 15/361,934, filed on Nov. 28, 2016.
(60) Provisional application No. 62/307,497, filed on Mar. 13, 2016.
(60) Provisional application No. 62/260,553, filed on Nov. 29, 2015.
(60) Provisional application No. 62/261,355, filed on Dec. 1, 2015.

(51) Int. Cl. G06Q 40/00; G06K 9/34; G06K 9/00; G06F 17/30

(52) U.S. Cl. CPC G06Q 40/123; G06F 17/30011; G06F 17/30303; G06K 9/344; G06K 9/00483

(57) ABSTRACT

A system and method for automatically generating reporting data based on an electronic document. The method includes analyzing the electronic document to determine at least one transaction parameter of a transaction, wherein the electronic document includes at least partially unstructured data; creating a template for the transaction, wherein the template is a structured dataset including the determined at least one transaction parameter; obtaining, based on the created template, a plurality of reporting requirements; and generating, based on the created template and the obtained plurality of reporting requirements, qualified reporting data.

### CROSS-REFERENCE TO RELATED APPLICATIONS

This application claims the benefit of U.S. Provisional Application No. 62/307,497 filed on Mar. 13, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to data analysis, and more particularly to generating reporting based on analysis of unstructured data.

### BACKGROUND

As businesses increasingly rely on technology to manage data related to operations, suitable systems for properly maintaining and reporting data have become crucial to success. Particularly for large businesses, the amount of data utilized daily by businesses can be overwhelming. Accordingly, manual review and reporting of such data is impractical, at best. In addition to normal sales data, businesses in countries where value-added taxes are applied collect and utilize even more data, thereby requiring additional reporting.

The Value-Added Tax (VAT) is a broadly based consumption tax assessed on the value added to goods and services. A particular VAT applies to most goods and services that are bought or sold within a given community. When a person travels abroad and makes a purchase that requires paying a VAT, that person may be entitled to a subsequent refund of the VAT for the purchase. Other taxes applied to purchases may similarly be refunded under particular circumstances. Further, sellers may offer rebates for purchases of products sold in certain locations and under particular circumstances. Such refunds of the purchase price may be reclaimed by following procedures established by the refunding entity.

The laws and regulations of many countries allow foreign travelers the right for reimbursement or a refund of certain taxes such as, e.g., VATs paid for goods and/or services abroad. As such laws and regulations are different from one country to another, determination of the actual VAT refunds that one is entitled to receive often requires that the seeker of the refund possess a vast amount of knowledge in the area of tax laws abroad. Moreover, travelers may seek refunds for VATs when they are not entitled to such refunds, thereby spending time and effort on a fruitless endeavor. Further, availability of the VAT refund may vary based on the type of purchase made and the presence of a qualified VAT receipt.

One procedure to request a refund is to physically approach a customs official at an airport, fill out a form, and file the original receipts respective of the expenses incurred during the visit. This procedure should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

As travelers are not familiar with specific laws and regulations for claiming a refund, the travelers may submit a claim for a refund even though they are not eligible. This procedure further unnecessarily wastes time if the traveler ultimately learns that he or she is not entitled to a refund. It would therefore be advantageous to provide a solution that would overcome the deficiencies of the prior art by providing an effective way to handle VAT refunds electronically and, preferably, over the Internet.

The challenges facing customers seeking a refund and, in particular, seeking VAT refunds, may result in customers becoming discouraged and failing to follow through on obtaining their refunds. This issue is further compounded when the customer is an employee of an enterprise because the customer is not directly benefiting from the refund. Moreover, employees may submit irrelevant or duplicate information that is unnecessary for seeking refunds. Filtering through such unnecessary information may be time-consuming, costly, and subject to a large degree of human error.

Moreover, businesses whose employees make purchases abroad must maintain records of transactions for which the business paid VATs, both for accounting purposes and for the purpose of seeking reclaims. Manual reporting based on such records is labor-intensive and subject to human error. Further, existing solutions for automatically reporting based on such records often require manual data entry, which is also subject to human error.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for generating reporting data based on an electronic document. The method comprises: analyzing the electronic document to determine at least one transaction parameter of a transaction, wherein the electronic document includes at least partially unstructured data; creating a template for the transaction, wherein the template is a structured dataset including the determined at least one transaction parameter; obtaining, based on the created template, a plurality of reporting requirements; and generating, based on the created template and the obtained plurality of reporting requirements, qualified reporting data.

Certain embodiments disclosed herein also include a non-transitory computer readable medium having stored thereon instructions for causing a processing circuitry to perform a process, the process comprising: analyzing an electronic document to determine at least one transaction parameter of a transaction, wherein the electronic document includes at least partially unstructured data; creating a template for the transaction, wherein the template is a structured dataset including the determined at least one transaction parameter; obtaining, based on the created template, a plurality of reporting requirements; and generating, based on the created template and the obtained plurality of reporting requirements, qualified reporting data.

Certain embodiments disclosed herein also include a system for generating reporting data based on an electronic document. The system comprises: a processing circuitry; and a memory, the memory containing instructions that, when executed by the processing circuitry, configure the system to: analyze an electronic document to determine at least one transaction parameter of a transaction, wherein the electronic document includes at least partially unstructured data; create a template for the transaction, wherein the template is a structured dataset including the determined at least one transaction parameter; obtain, based on the created template, a plurality of reporting requirements; and generate, based on the created template and the obtained plurality of reporting requirements, qualified reporting data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a data integrity manager according to an embodiment.

FIG. 3 is a flowchart illustrating a method for automatically generating reporting data according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automatically generating reporting data based on an electronic document. In an embodiment, a dataset is created based on an electronic document. The at least one electronic document is at least partially unstructured. A template of transaction attributes is created. Reporting requirements are obtained based on the template. Based on the template and the reporting requirements, it is determined whether a transaction of the electronic document is qualified and, if so, qualified reporting data is generated. The qualified reporting data may include, e.g., a completed value-added tax (VAT) reclaim form, at least one electronic document evidencing a transaction, or both. The generated qualified reporting data may be sent to, e.g., a reporting authority server.

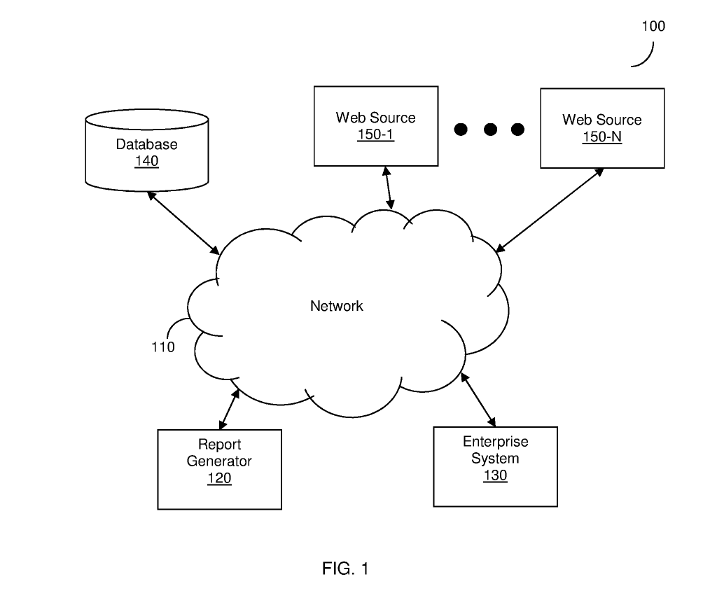

FIG. 1 shows an example network diagram 100 utilized to describe the various disclosed embodiments. In the example network diagram 100, a report generator 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by each of the enterprise system 130 may include, but is not limited to, electronic documents (e.g., an image file showing, for example, a scan of an invoice, a text file, a spreadsheet file, etc.). Data included in each electronic document may be structured, semi-structured, unstructured, or a combination thereof. The structured or semi-structured data may be in a format that is not recognized by the report generator 120 and, therefore, may be treated like unstructured data.

The database 140 stores at least data evidencing transactions. Such data may include, but is not limited to, evidentiary electronic documents including information related to transactions. The evidentiary electronic documents may include, but are not limited to, invoices, receipts, and the like.

The web sources 150 store at least requirements for data reporting (e.g., for reporting and claiming VAT refunds). The requirements may be stored in the form of, for example, rules. The web sources 150 may further store data utilized to generate reports such as, but not limited to, fillable reporting forms (e.g., a fillable VAT reclaim form). Different web sources 150 may store different reporting requirements and forms (e.g., reporting requirements or forms for different countries). As a non-limiting example, the web source 140-1 may store regulatory requirements for VAT reporting in France. As another non-limiting example, the web source 140-8 may store VAT reclaim forms utilized for reporting VAT reclaims in Italy.

In an embodiment, the report generator 120 is configured to generate a template based on transaction parameters identified using machine vision in an electronic document. In a further embodiment, the report generator 120 is configured to compare the template to at least one reporting requirement to determine if a transaction represented by the data of the template is qualified (e.g., for a VAT reclaim). In yet a further embodiment, the report generator 120 is configured to generate qualified reporting data based on the template when it is determined that the transaction is qualified. The generated qualified reporting data may include, but is not limited to, an electronic document (e.g., an electronic document including a completed VAT reclaim form), data evidencing the transaction (e.g., an electronic document including a receipt or invoice related to the transaction), or both. The qualified reporting data may be sent to, e.g., a reporting authority (for example, an appropriate tax authority).

In an embodiment, the report generator 120 is configured to create datasets based on electronic documents including data that is at least partially unstructured (e.g., unstructured data, semi-structured data, or structured data having an unknown structure). To this end, the report generator 120 may be further configured to utilize optical character recognition (OCR) or other image processing to determine data in the electronic document.

In an embodiment, the report generator 120 is configured to analyze the created datasets to identify transaction parameters related to transactions indicated in the electronic documents. In another embodiment, the report generator 120 may be configured to determine whether the created datasets are eligible for reclaim based on, e.g., whether the dataset meets at least one predetermined constraint.

In an embodiment, the report generator 120 is configured to create a template based on the created datasets. The template is a structured dataset including the identified transaction parameters. The created template is utilized as the potential reporting template.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

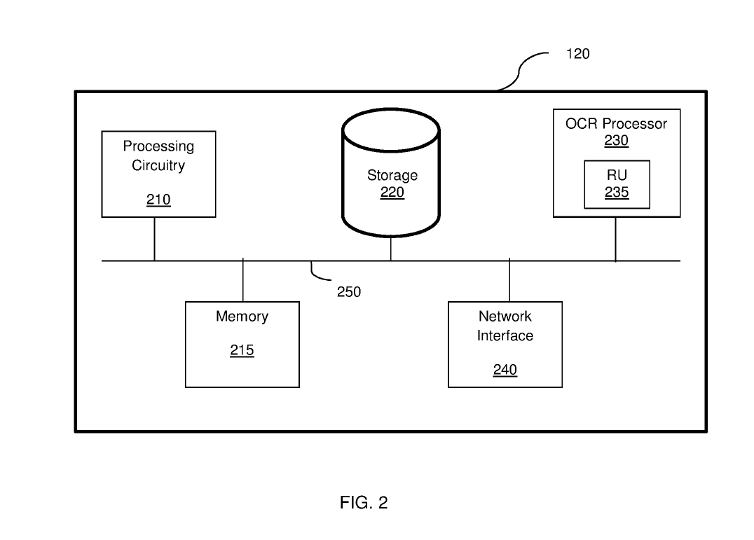

FIG. 2 is an example schematic diagram of the report generator 120 according to an embodiment. The report generator 120 includes a processing circuitry 410 coupled to a memory 215, a storage 220, an optical character recognition (OCR) processor 230, and a network interface 240. In an embodiment, the components of the report generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processing circuitry 210, cause the processing circuitry 210 to perform the various processes described herein. Specifically, the instructions, when executed, cause the processing circuitry 210 to perform automatic generation of reporting data based on an electronic document, as described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition unit (RU) 235 configured to identify patterns, features, or both, in unstructured data sets. Specifically, in an embodiment, the OCR processor 230 is configured to identify at least characters in the unstructured data. The identified characters may be utilized to create a validation dataset including data required for validation of a transaction.

The network interface 240 allows the report generator 120 to communicate with the enterprise system 130, the database 140, the web sources 150, or a combination of, for the purpose of, for example, retrieving data, storing data, and the like.

It should be understood that the embodiments described herein are not limited to the specific architecture illustrated in FIG. 2, and other architectures may be equally used without departing from the scope of the disclosed embodiments.

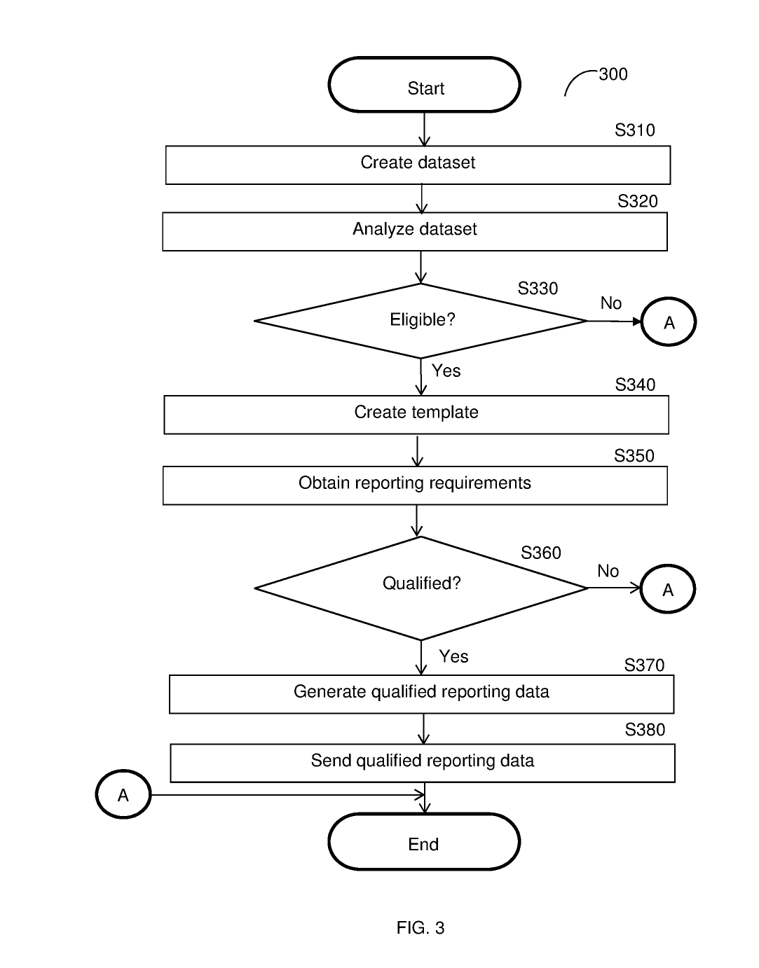

FIG. 3 is an example flowchart 300 illustrating a method for generating reporting data based on electronic documents according to an embodiment. In an embodiment, the method may be performed by the report generator 120.

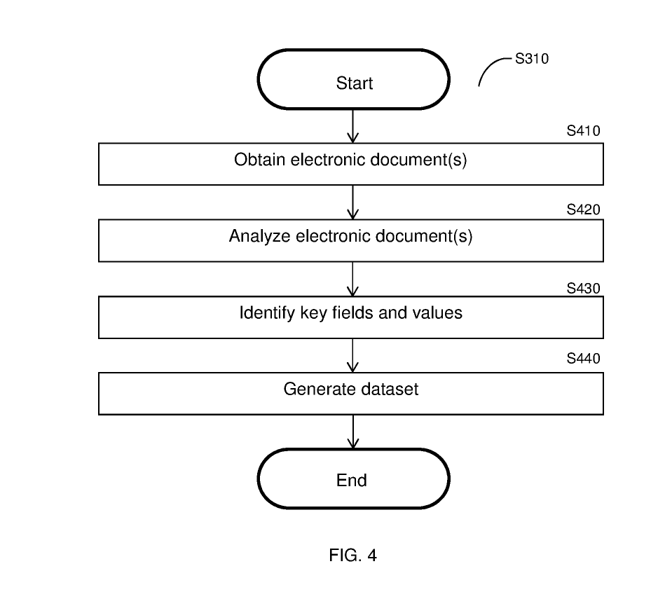

At S310, a dataset is created based on an electronic document including information related to a transaction. The electronic document may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

At S320, the created dataset is analyzed. In an embodiment, analyzing the dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the dataset may also include identifying the transaction based on the dataset.

At optional S330, it is determined, based on the analysis, whether the created dataset is eligible for reporting and, if so, execution continues with S340; otherwise, execution terminates. In an embodiment, S330 may include determining whether the created dataset meets at least one predetermined constraint. A dataset may be eligible for reporting if, e.g., the dataset meets the at least one predetermined constraint. Such predetermined constraints may include, but are not limited to, requirements on types of information needed for validation, accuracy requirements, or a combination thereof. For example, if an electronic document does not include a country for the merchant enterprise in a transaction or a price of the transaction, successful reporting may not be possible. Determining whether the transaction is eligible for reporting may reduce use of computing resources by only reporting using datasets meeting minimal requirements.

In another embodiment, S330 may further include determining at least one constraint based on the created dataset. In a further embodiment, determining the at least one constraint may include searching in at least one database based on the created dataset (e.g., using a location of the merchant enterprise indicated in the created dataset). In yet a further embodiment, S330 may also include analyzing at least one reporting requirements electronic document (e.g., a VAT reclaim form) to determine the at least one constraint. The analysis may further include performing OCR or other image processing on each reporting requirements electronic document. For example, based on an analysis of a VAT reclaim form having fields “price,” “product(s) purchased,” and “location,” the at least one constraint may require that the dataset include a price, at least one good or service, and a location to be eligible.

In another embodiment, when it is determined that the data is not eligible for reporting, additional data, replacement data, or both may be retrieved from at least one data source and included in the created dataset. As a non-limiting example, in case a purchase was made in a country where the merchant name is required in order to successfully reclaim a VAT and an invoice in the data does not include the merchant's name, the merchant's name can be extracted from a governmental database based on other information indicated in the invoice. In a further embodiment, upon retrieving the replacement information, execution continues with S340. In another embodiment, upon retrieving the replacement data, it is determined whether the dataset with the replacement data is eligible and, if so, execution continues with S340; otherwise, execution terminates.

At S340, a template is created based on the analyzed dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S350, a plurality of reporting requirements is obtained based on the template. In an embodiment, S350 may include selecting at least one data source from which the reporting requirements can be obtained. In a further embodiment, the selection may be based on the template. As a non-limiting example, for reclaiming VATs based on purchases made in Europe, in order to successfully reclaim a VAT, a seller of a transaction must be listed in a white list of the European organization. Therefore, a web source storing the white list is selected and queried. In a further embodiment, the at least one reporting requirement may include one or more rules for determining potential reporting parameters. As a non-limiting example, the at least one reporting requirement may include a rule for calculating an amount for a VAT reclaim based on one or more transaction parameters.

In another embodiment, S350 includes retrieving the at least one reporting requirement from at least one data source (e.g., a database of a regulatory authority that establishes requirements for VAT reclaims). In a further embodiment, the at least one reporting requirement may be retrieved based on at least a portion of the template. Each potential reporting parameter is a parameter that may be requested or otherwise reported. As a non-limiting example, if a location indicated in a “location” field of the template is France, reporting requirements may be obtained from a server of a French tax authority.

In yet another embodiment, S350 may include retrieving at least one reporting electronic document such as, but not limited to, an electronic document including a VAT reclaim request form. In a further embodiment, S350 includes determining the at least one reporting requirement by analyzing, via machine imaging, the retrieved at least one reporting electronic document.

At S360, based on the obtained reporting requirements and the created template, it is determined if the transaction indicated in the template is qualified and, if so, execution continues with S370; otherwise, execution terminates. In an embodiment, S360 includes comparing data in the template to data in the reporting requirements. The transaction may be qualified if each of the reporting requirements is met. As a non-limiting example, a transaction may be qualified based on reporting requirements from a German tax authority if the template includes the location “Germany”, purchased products belonging to a list of predetermined VAT-reclaim eligible products, and an indication that the buyer is from a country other than Germany.

At S370, when it is determined that the transaction is qualified, qualified reporting data is generated. In an embodiment, S370 includes generating a reporting electronic document including data meeting the obtained reporting requirements. In a further embodiment, S370 may also include retrieving an electronic document to be completed. As a non-limiting example, S370 may include generating, using an electronic document including a blank VAT reclaim form and the created template, a completed VAT reclaim form. The retrieved electronic document (e.g., the blank VAT reclaim form) may be structured to allow for insertion of particular information. The retrieved electronic document may be completed based on such structure.

In another embodiment, S370 may further include obtaining at least one evidentiary electronic document related to the transaction. In a further embodiment, S370 may include querying, using data of the template, at least one data source storing information related to transactions. As a non-limiting example, an electronic document including a receipt for a purchase may be retrieved from a merchant server of a merchant of the transaction by querying the merchant server using a transaction identifier of the template.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key filed values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically generating reporting data based on an electronic document, comprising:
analyzing the electronic document to determine at least one transaction parameter of a transaction, wherein the electronic document includes at least partially unstructured data;
creating a template for the transaction, wherein the template is a structured dataset including the determined at least one transaction parameter;
obtaining, based on the created template, a plurality of reporting requirements; and
generating, based on the created template and the obtained plurality of reporting requirements, qualified reporting data.

2. The method of claim 1, further comprising:
comparing the created template to the plurality of reporting requirements to determine whether the transaction is qualified for reporting, wherein the qualified reporting data is generated when the transaction is determined qualified for reporting.

3. The method of claim 1, wherein generating the qualified reporting data further comprises:
generating, based on the created template, a reporting electronic document, wherein the qualified reporting data includes the generated reporting electronic document.

4. The method of claim 1, wherein generating the qualified reporting data further comprises:
retrieving, based on the created template, at least one evidentiary electronic document evidencing the transaction, wherein the qualified reporting data includes the retrieved at least one evidentiary electronic document.

5. The method of claim 1, wherein analyzing the electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

6. The method of claim 1, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

7. The method of claim 6, wherein analyzing the electronic document further comprises:
performing optical character recognition on the electronic document.

8. The method of claim 6, further comprising:
performing a cleaning process on the extracted at least a portion of the determined data.

9. The method of claim 6, further comprising:
checking if each piece of data of the extracted at least a portion of the determined data is completed; and
for each piece of data that is not completed, performing at least one of: querying at least one external source, and correlating the determine data with data of at least one previously analyzed electronic document.

10. The method of claim 1, wherein the transaction is at least a financial transaction, and wherein the reporting data is at least data related to reclaim value-add tax.

11. A non-transitory computer readable medium having stored thereon instructions for causing a processing circuitry to perform a process, the process comprising:
analyzing an electronic document to determine at least one transaction parameter of a transaction, wherein the electronic document includes at least partially unstructured data;
creating a template for the transaction, wherein the template is a structured dataset including the determined at least one transaction parameter;
obtaining, based on the created template, a plurality of reporting requirements; and
generating, based on the created template and the obtained plurality of reporting requirements, qualified reporting data.

12. A system for validating a transaction represented by an electronic document, comprising:
a processing circuitry; and
a memory, the memory containing instructions that, when executed by the processing circuitry, configure the system to:
analyze an electronic document to determine at least one transaction parameter of a transaction, wherein the electronic document includes at least partially unstructured data;
create a template for the transaction, wherein the template is a structured dataset including the determined at least one transaction parameter;
obtain, based on the created template, a plurality of reporting requirements; and
generate, based on the created template and the obtained plurality of reporting requirements, qualified reporting data.

13. The system of claim 12, wherein the system is further configured to:
compare the created template to the plurality of reporting requirements to determine whether the transaction is qualified for reporting, wherein the qualified reporting data is generated when the transaction is determined qualified for reporting.

14. The system of claim 12, wherein the system is further configured to:
generate, based on the created template, a reporting electronic document, wherein the qualified reporting data includes the generated reporting electronic document.

15. The system of claim 12, wherein the system is further configured to:
retrieve, based on the created template, at least one evidentiary electronic document evidencing the transaction, wherein the qualified reporting data includes the retrieved at least one evidentiary electronic document.

16. The system of claim 12, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

17. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

18. The system of claim 17, wherein the system is further configured to:
perform optical character recognition on the electronic document.

19. The system of claim 17, wherein the system is further configured to:
perform a cleaning process on the extracted at least a portion of the determined data.

20. The system of claim 17, wherein the system is further configured to:
check if each piece of data of the extracted at least a portion of the determined data is completed; and
for each piece of data that is not completed, performing at least one of:
querying at least one external source, and correlating the determine data with data of at least one previously analyzed electronic document.

21. The system of claim 12, wherein the transaction is at least a financial transaction, and wherein the reporting data is at least data related to reclaim value-add tax.
